(19) United States
(12) Patent Application Publication
(10) Pub. No.: US 2015/0378393 A1
(43) Pub. Date: Dec. 31, 2015

(54) MOBILE DEVICE WITH MULTIPLE INTERCONNECTED DISPLAY UNITS

(71) Applicants: Menachem ERAD, (US); Yariv ERAD, (US)

(72) Inventors: Menachem ERAD, Ashdod (IL); Yariv ERAD, Kidron (IL)

(21) Appl. No.: 14/764,193

(22) PCT Filed: Feb. 9, 2014
(86) PCT No.: PCT/IL14/50135

§ 371 Date: Jul. 29, 2015

Related U.S. Application Data
(60) Provisional application No. 61/762,910, filed on Feb. 10, 2013.

(51) Int. Cl. G06F 1/16; G06F 3/14; G06K 9/00; G06F 3/0486; G06F 3/16

(52) U.S. Cl. CPC G06F 1/1616; G06F 3/0486; G06F 3/167; G06K 9/00006; G06F 3/1446; G06F 1/1624; G06F 1/1647; G09G 2300/023

(57) ABSTRACT

The subject matter discloses a mobile device comprising a body, comprising a processor and a memory; a plurality of display units, at least one of the plurality of display units receives data from the body; a plurality of connectors configured to connect the plurality of display units such that data flows from one display unit to another display unit via a connector of the plurality of connectors; a designation unit to designate what is displayed on each display of the plurality of display units; at least one display unit compartment inside the body for storing the plurality of display units, a display unit of the plurality of display units is slide-able out of the at least one display unit compartment. In some cases, some of the display units are transparent.

### FIELD OF THE INVENTION

The subject matter relates generally to a mobile device comprising multiple display units.

### BACKGROUND OF THE INVENTION

New electronic devices in the market enable transfer and display of different types of data, such as audio, video, images, telemetry, and the like, while enabling connectivity of the device while on the move. Such connectivity is enabled in most places through rapidly developing cellular networks, Wi-Fi networks, Bluetooth, near field communication networks, and the like. As such, the electronic devices have become personal, such as mobile phones, tablets and other types that can be carried while on the move.

In some cases, bigger devices, such as televisions, tablets, laptops, desktops or the like are shared by multiple users that jointly view the screen of the bigger device. In some cases, multiple users use multiple devices to view the same event. For example, multiple users playing a multi-player game online, where each use of the multiple users plays the game from the user's personal device. Each user is able to view what other users are viewing throughout the duration of the game.

Samsung has published a disclosure on a dual display smartphone, in which two display units are connected via a hinge such that the user can view different content in each display unit. One of the display units can fold over the other or be positioned next to the other. Samsung also published another disclosure of a flexible display made of a flexible material, which is foldable or collapsible.

### SUMMARY

The present invention discloses a mobile devices that comprises several interconnected display units. Each display unit is defined by having an independent housing in which the electronic circuitry of the unit resides. The display units are connected to each other using physical connectors that enable data transfer or using wireless transceivers, or both. The multiplicity of interconnected display units enable various configurations of the mobile device—for example enable a user of the device to mount the display units one next to the other and enjoy a larger screen. For example, 6 display units of a standard mobile device assemble a display device of a tablet. In other cases, the display units may be directed at different directions and enable a group of persons to view the same image or movie from different locations, for example from both ends of a table.

It is another object of the subject matter to disclose a mobile device comprising a body, comprising a processor and a memory; a plurality of display units, wherein each display unit of the plurality of display units is arranged according to predefined configurations, at least one of the plurality of display units receives data from the body; a plurality of connectors configured to connect the plurality of display units such that data flows from one display unit to another display unit via a connector of the plurality of connectors; a designation unit to designate what is displayed on each display of the plurality of display units; at least one display unit compartment inside the body for storing the plurality of display units, a display unit of the plurality of display units is slide-able out of the at least one display unit compartment.

In some cases, the plurality of connectors enable folding the plurality of the display units into the predefined configurations. In some cases, the designation unit designates a portion of an image to be displayed m each display unit of the plurality of display units, such that the image is displayed by the plurality of display units. In some cases, the designation unit designates a different display to each display unit of the plurality of display units.

In some cases, the at least one connector of the plurality of connectors enables disconnecting a display unit of the plurality of display units from the mobile device. In some cases, the at least one display unit of the plurality of display units comprises a transceiver unit to wirelessly transmit and receive data from the body of the mobile device. In some cases, at least one connector of the plurality of connectors comprises a wire line connection that enables extending the distance from a display unit of the plurality of display units and the body of the mobile device.

In some cases, at least one connector of the plurality of connectors enables a display unit of the plurality of display units to rotate relative to a surface of the body of the mobile device, wherein the display unit is connected to the body.

In some cases, two display units of the plurality of the display units are connected to the body via two different connectors of the plurality of connectors, wherein the two different connectors enable the two display units to rotate relative to the surface of the body of the mobile device.

In some cases, a display unit of the plurality of display units folds from a bottom of the mobile device.

In some cases, the mobile device further comprising an orientation unit to obtain an orientation data of at least one display unit of the plurality of display units, wherein the designation unit determines the display of the at least one display unit according to orientation data. In some cases, the orientation unit stabilizes and orients a display of the at least one display unit of the plurality of display units according to location, movement and orientation of the at least one display unit of the plurality of display units.

In some cases, the mobile device further comprising a display optimization unit to correct environmental effect on an image quality of a display unit of the plurality of display units.

In some cases, the mobile device further comprising a plurality of input units, each input unit is associated with a display unit of the plurality of display units, said plurality of input units receive commands from one or more users viewing the plurality of displays.

In some cases, each input unit of the plurality of input units recognizes voice commands of a user. In some cases, a display unit of the plurality of display units displays personalized content of the user recognized by the input unit. In some cases, an input unit of the plurality of input units is a remote control. In some cases, the remote control is activated upon identification of a person using a fingerprint detection sensor.

In some eases, each display unit of the plurality of display units is customizable according to a user's predefined specification.

In some cases, the display unit is automatically activated responsive to being slide-able out of the at least one display unit compartment.

In some cases, the body comprises at least two openings, wherein at least two display units of the plurality of display units are slide-able from the at least one display unit compartment via the at least two openings. In some cases, the body stores at least two display units in the at least one display unit compartment, wherein the at least two display units are horizontally and/or vertically stacked. In some cases, at least one display unit of the at least two display units comprises a second display unit compartment, said second display unit compartment stores additional display units.

In some cases, the designation unit enables dragging an item from a first display unit of the plurality of the display units to a second display unit of the plurality of the display units.

In some cases, a portion of a first display unit protrudes from another display unit, wherein the designation unit determines the display of the first display unit according to the portion of the first display unit not overlapped by the second display unit.

In some cases, at least a portion of the plurality of display units is configured to show personalized content.

In some cases, personalized content associated with two persons is displayed simultaneously via two display units of the plurality of display units.

In some cases, the predefined configuration is a closed configuration.

It is another object of the subject matter to disclose a mobile device comprising a body, comprising a processor and a memory; a plurality of transparent display units, at least one of the plurality of display units receives data from the body; a plurality of connectors configured to connect the plurality of display units such that data flows from one display unit to another display unit via a connector of the plurality of connectors;

a designation unit to designate what is displayed on each display of the plurality of display units; at least one display unit compartment inside the body for storing the plurality of display units, a display unit of the plurality of display units is slide-able out of the at least one display unit compartment.

In some cases, at least two transparent display units are foldable, to be mounted one on top of the other. In some cases, the foldable at least two transparent display units are configured to compare a first image displayed on a first display unit of the least two transparent display units and a second image displayed on a second display unit of the least two transparent display units. In some cases, the compartment is transparent. In some cases, at least one display unit of the plurality of transparent display units display data when positioned inside the compartment. In some cases, at least one display unit of the plurality of transparent is controlled and activated when positioned inside the compartment.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a mobile device to enable various configurations of a plurality of displays, according to some exemplary embodiments of the of the subject matter;

FIG. 2 shows a display unit of a plurality of display units, according to some exemplary embodiments of the subject matter;

FIGS. 3A-3C show various configurations of a mobile device with at least one compartment having a plurality of displays, according to some exemplary embodiments of the subject matter;

FIGS. 4A-4D shows various configurations of a mobile device with a plurality of display units connected via physical connectors, according to some exemplary embodiments of the subject matter;

FIG. 5 shows a mobile device with three display units showing three different images, according to some exemplary embodiments of the subject matter;

FIG. 6 shows a mobile device with a plurality of display units connected showing a single image, according to some exemplary embodiments of the subject matter;

FIG. 7 shows a mobile device with a wireless display unit, according to some exemplary embodiments of the subject matter;

FIG. 8 shows a mobile device with a display unit connected through an extendable wire, according to some exemplary embodiments of the subject matter;

FIG. 9 shows a mobile device with a display unit arranged at a corner of the mobile device, according to some exemplary embodiment of the subject matter;

FIG. 10 shows a mobile device with a plurality of display units arranged in a closed configuration, according to some exemplary embodiment of the subject matter;

FIG. 11 shows a mobile device controlled by a remote control unit, according to exemplary embodiments of the subject matter;

FIG. 12 shows a mobile device, according to exemplary embodiments of the subject matter;

FIG. 13 shows a mobile device, according to exemplary embodiments of the subject matter;

FIG. 14 shows a mobile device in a closed configuration, according to exemplary embodiments of the subject matter;

FIG. 15 shows a mobile device with three display units, according to exemplary embodiments of the subject matter;

FIG. 16 shows a mobile device with t WO transparent display units, according to exemplary embodiments of the subject matter; and,

FIG. 17 shows a mobile device with three display units inside a compartment, according to exemplary embodiments of the subject matter.

### DETAILED DESCRIPTION

The subject matter discloses a mobile device comprising multiple display units, according to exemplary embodiments.

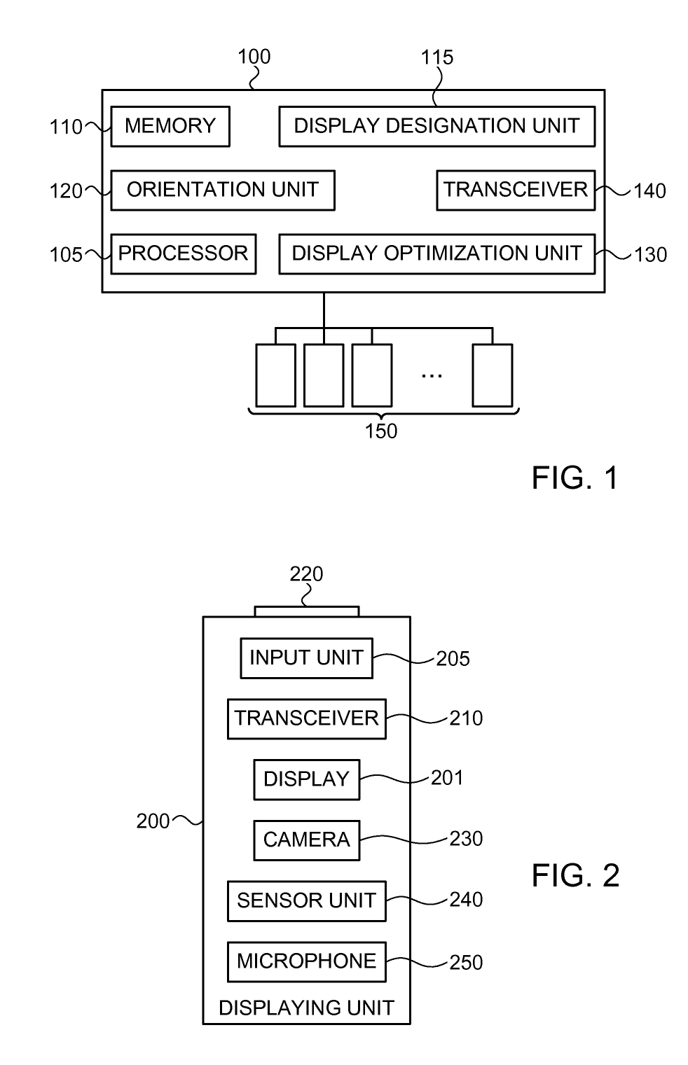

FIG. 1 shows a mobile device comprising one or more display units. according to some exemplary embodiments of the subject matter. The mobile device 100 comprises a processor 105 to execute and control actions within software of the mobile device 100. The mobile device 100 comprises a memory 110 for storing data. In some cases, each display unit of a plurality of display units 150 comprises an independent processor and memory. The mobile device 100 comprises a plurality of display units 150, which may be arranged in predetermined configurations as will be further disclosed herein. The plurality of display units 150 display content to one or more users of the mobile device 100. For example each display unit of the plurality of the display units 150 may different content or the same content. In such a scenario, at least some of the plurality of display units 150 are positioned to face different directions, such that several persons sitting in several directions from the mobile device 100 will be able to view the same content simultaneously, for example, four persons sitting in 4 corners of a table.

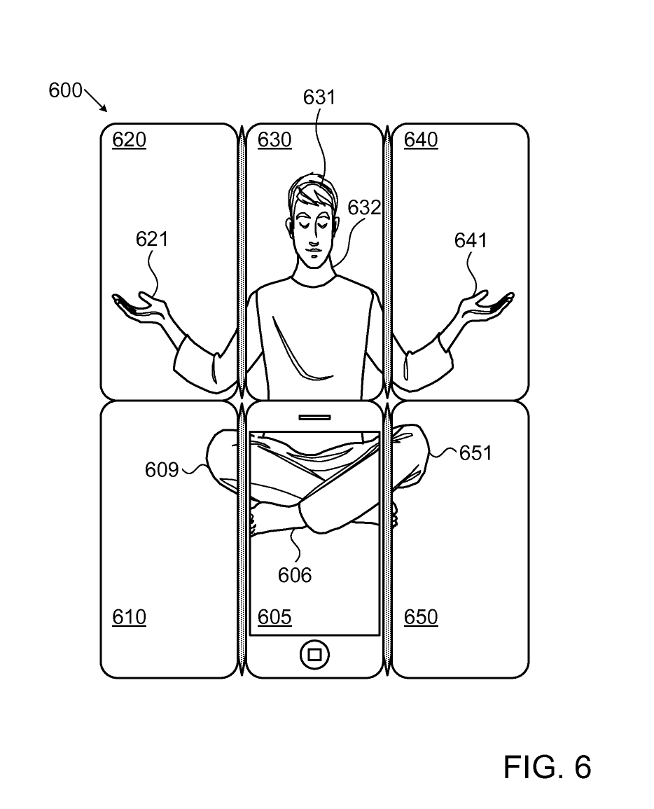

The mobile device 100 comprises a display designation unit 115, which designates what each display unit of the plurality of display units 150 displays. The display designation unit 115 may designate the same display in each of the plurality of display units 150, or may designate a portion of larger image, in case the plurality of display units 150 form a unified larger display, as shown in FIG. 6.

In some exemplary embodiments of the subject matter, more than one user uses the mobile device 100 simultaneously and the memory 110 stores a user profile for at least one user of the one or more users, The user may access the user profile through a display unit of the plurality of display units 150. The designation unit 115 designates the display unit to receive user content according to the user's profile, for example, preferred applications, links to multimedia saved on the mobile device 100, documents, and the like. The mobile device 100 enables two or more persons to view their email accounts, as each email account is displayed in a different display unit of the plurality of display units 150 according to user credentials inputted by two different persons. The display designation unit 115 may determine transfer of data or content from a first display unit of the plurality of display units 150 to a second display unit of the plurality of display units 150. For example, the user of the first display unit sends a message to the user of the second display unit, the display designation unit 115 identifies the display unit w which the message is to be sent and directs the data thereto.

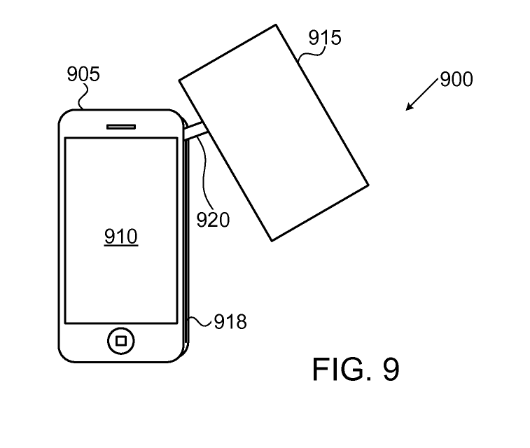

The mobile device 100 comprises an orientation unit 120, which orients an image displayed on a display unit of the plurality display units 150. As the orientation oil the display may change, for example when the user changes the position of the display units to be in a widescreen format, an upright format, or in case one a surface of a first display unit is parallel to the surface or another display unit and is positioned 45 degrees to the other display unit. In such case, the orientation unit 120 orients the image of the first display unit and changes the image to conform to the difference in angles, as shown in FIG. 9.

The mobile device 100 may also include an image stabilization unit for stabilizing the image, and a synchronization mechanism to synchronize content, in case the same content is displayed in two or more display units of the mobile device 100. The mobile device 100 may include sensors of various kinds, such as a gyroscope, a motion sensor, accelerometers and others. Such sensors, image stabilization unit and additional features as disclosed below, such as cameras and microphones, may be disposed in at least one of the plurality of display units of the mobile device 100.

The mobile device 100 may also comprise a display optimization unit 130, which enhances an image displayed on the display unit according to change in environmental conditions. For example, the display unit is viewed outdoors and there is a glare from the sun, the display optimization unit 130 darkens the screen to reduce the glare on the screen. The mobile device 100 comprises a transceiver 140, which enables the mobile device 100 to communicate with external units such as printers and the cellular network. In some exemplary cases, at least a portion of the plurality of the display units 150 have wireless capabilities and include independent transceivers.

FIG. 2 shows a display unit of a plurality of display units that assemble the mobile device 100, according to some exemplar embodiments of the subject matter. The display unit 200 comprises a screen 201, which displays visual data for a user using the display unit 200. The display unit 200 comprises an input unit 205, which enables a user to input commands to the display unit 200. In some exemplary cases, the input unit 205 is a touch screen of the screen 201. The input unit 205 may be a physical button or switch accessible in the body or the housing of the display unit 200. The display unit 200 comprises a connector 220, which connects the display unit 200 to other display units or to a main unit of the mobile device 100 of FIG. 1. The connector 220 may be a wire to connect the display unit 200 to another physical module of the mobile device 100. The connector 220 may be a conductive layer positioned in some of the edges of the display unit 200, such that when another display unit is positioned next to the display unit 200, data is transferred between the display unit 200 and the other display unit via the conductive layer, for example by converting the data into electrical current which is later composed into data by the receiving side. The display unit 200 comprises a display unit transceiver 210, which enables the display unit 200 to wirelessly communicate with other physical modules of the mobile device 100. The display unit transceiver 210 may also enable the display unit 200 to independently communicate with the cellular network or the Internet, not to have to be rely on the main unit of the mobile device 100.

In some exemplary cases, at least one of the plurality of display units comprise a camera 230, a sensor unit 240 and a microphone 250. In some other cases, the entire front surface of the display units is used to display content.

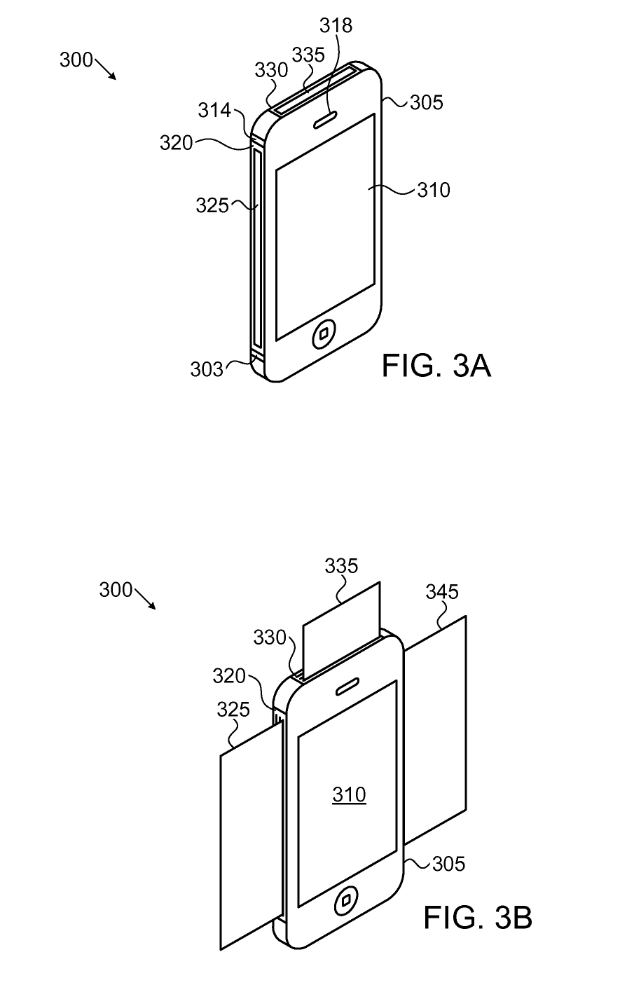

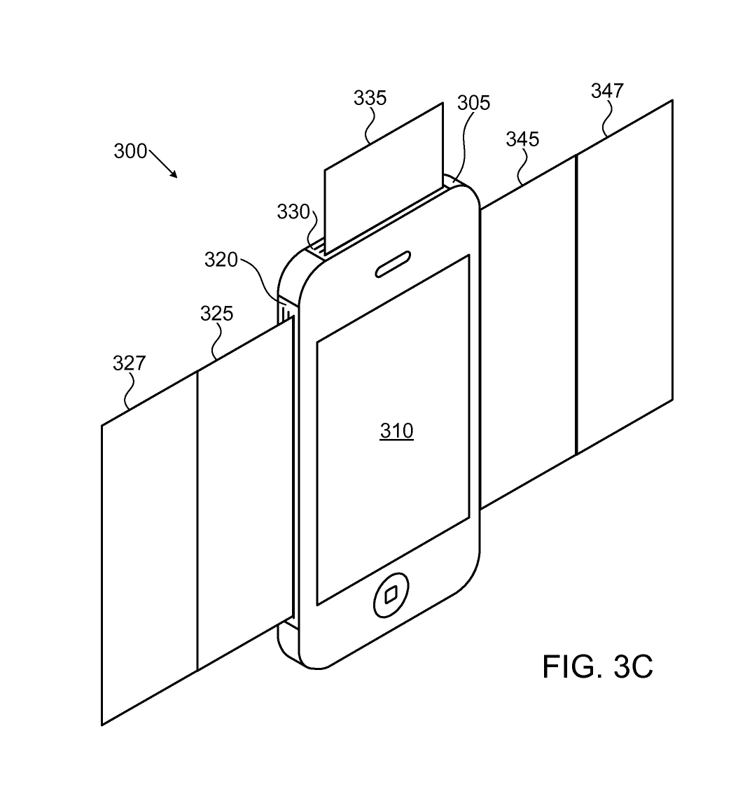

FIGS. 3A-3C show various configurations of a mobile device with a plurality of display units, according to some exemplary embodiments of the subject matter. FIG. 3A shows a mobile device comprising a compartment for storing a plurality of display units, according to some exemplary embodiments of the subject matter. The mobile device 300 comprises a body 305, which stores the various components of the mobile device 300. The body 305 comprises a main display unit 310, which is connected to the body 305. The body 305 comprises one or more compartments, which store additional display units. The additional display units are slidable from the compartment inside the body 305, for example via openings in the body 305. Such openings may include a left opening 320 and a top opening 330. A left display unit 325 residing in the body 305 is slidable from the left opening 320 and a top display unit 335 residing in the body 305 is slidable from the top opening 330. Each compartment of the one or more compartments may store one or more display units of the plurality of display units. The display units may be automatically slidable from the compartment of the body 305, for example responsive to an input provided in the main display unit 310 or upon pressing a physical button 314 or switch on the body 305. The mobile device 300 may also include a camera 318.

In some exemplary cases, the body 305 of the mobile device 300 comprises electronic circuitry 303, such as a memory, a transceiver and a processor. The body 305 may be defined by a physical housing containing the electronic circuitry 303, the left display unit 325 and the top display unit 335.

FIG. 3B shows the mobile device 300 with three display units of the plurality of display units extracted from the one or more compartments, according to some exemplary embodiments of the subject matter. A left display unit 325 of the plurality of display units is slid from the left opening 320 and enables the mobile device 300 to display content on the left display unit 325, in addition to content on the main display unit 310. A top display unit 335 of the plurality of display units may be removed from the compartment via the top opening 330 by sliding the top display unit 335 vertically from the body of the mobile device 300. The right display unit 345 may be removed from a right opening (not shown). The display units 325, 335 and 345 may be contained in a single compartment at the body 305 or divided into more than one compartment.

FIG. 3C shows the mobile device 300 with five display units extracted from the one or more compartments, according to some exemplary embodiments of the subject matter. The mobile device 300 comprises two display units of the plurality of display units that are retractable from behind other display units of the plurality of display units. For example, a second left display unit 327 is retracted from behind the left display unit 325, and a second right display unit 337 is retracted from behind the right display unit 335, The second left display unit 327 and the second right display unit 337 are retracted by a sliding motion. In some cases, the second left display unit 327 and the second right display unit 337 are slid from the body 305 of the mobile device 300 when the left display unit 325 and the right display unit 335 are slid therefrom, and retracted afterwards.

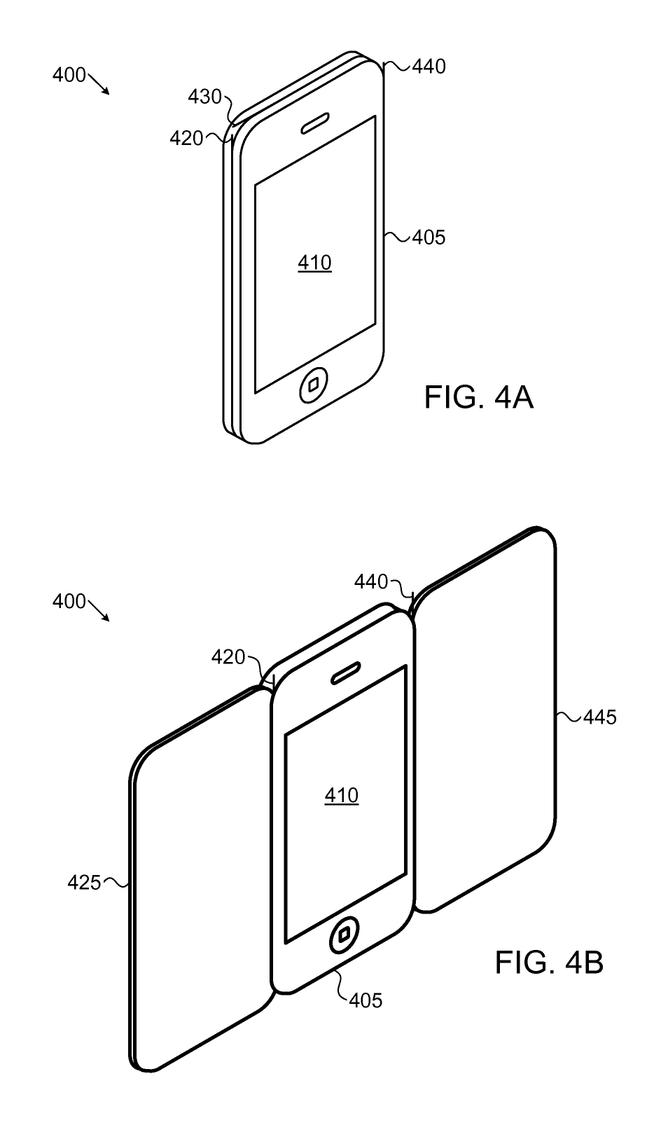

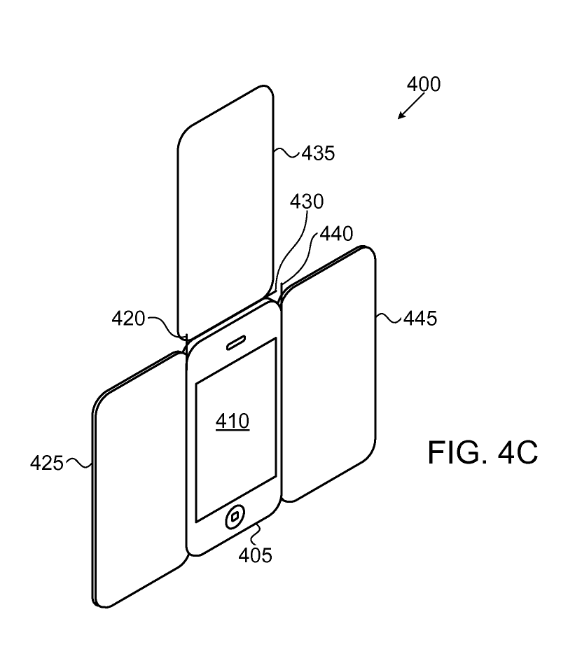

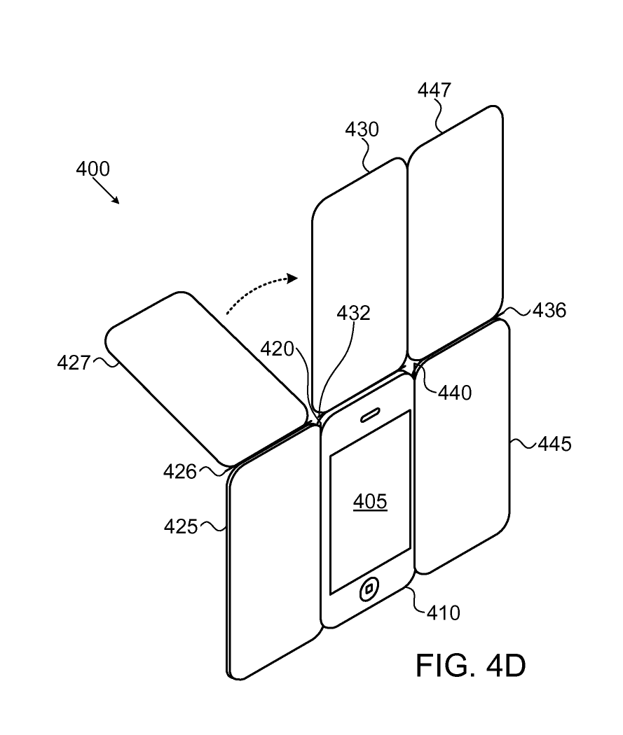

FIGS. 4A-4D shows various configurations of a mobile device with a plurality of display units, according to some exemplary embodiments of the subject matter. FIG. 4A shows a mobile device comprising compartments for storing a plurality of display units, according to some exemplary embodiments of the subject matter. The mobile device 400 comprises a body 405 and a main display unit 410. The body 405 comprises one or more compartments, the height of the compartment may be smaller than the height of the body 405. The body 405 comprises one or more connectors, which connect the plurality of the display units to the body 405. For example, the mobile device 400 comprises a left connector 420, a top connector 432, a right connector 440 and a bottom connector (not shown). The connectors 420, 432 and 440 may be physical connectors that are connected to the body 405 and configured to allow transfer of data from the body 405 of the mobile device 400 to other display units of the plurality of display units. The connectors 420, 432 and 440 may be removable from the body 405, or may be maneuverable 405, such that the angle between the connectors 420, 432 and 440 and the surface of the body 405 is adjustable.

FIG. 4B shows the mobile device 400 with two display units slid out of the compartment, according to some exemplary embodiments of the subject matter. The compartments of the mobile device 400 store display units, for example the two display units 425, 445. The two display units may be a left display unit 425 which rotates along the left connector 420, and a right display unit 445 that rotates along the right connector 440. The two display units may he stored along a back (not shown) of the mobile device. In case the two display units 425, 445 are rotatable around the body 405, the connectors 420 and 440 are physical hinges at the end of the body 405. In some other cases, the connectors 420, 440 are removable and their position on the body 405 may change, enabling different configuration of the mobile device 400.

FIG. 4C shows the mobile device 400 with three display units slid out of the compartment, according to some exemplary embodiments of the subject matter. The three display units are the left display unit 425, the right display unit 445 and a top display unit 430. The top display unit 430 is rotatable around a top connector 432. Allowing the display units to rotate around the connectors may also enable the display units to fold one on top of the other.

FIG. 4D shows the mobile device 400 with six display units slid out of the body, according to some exemplary embodiments of the subject matter. In some eases, additional screens may be extracted from behind already extracted display units. For example, a top left display unit 427 is connected to the left display unit 425 by a top left connector 426, top center display unit 430 is connected to the center display unit 410 by a top connector 432 and a top right display unit 447 is connected to right display unit 445 by a right connector 436. The image designation unit 115 of FIG. 1 may determine that each display unit of the display units 427, 430, 447, 445, 410 and 425 display a portion of an image and enable the mobile device 400 to show an image in a size of a tablet. In some exemplary cases, one of the display units slid from the body 405 also comprise a compartment, a secondary compartment, in which additional display units are stored. For example, the display unit 430 may store the display units 427 and 447, which slid from openings of the display unit 430.

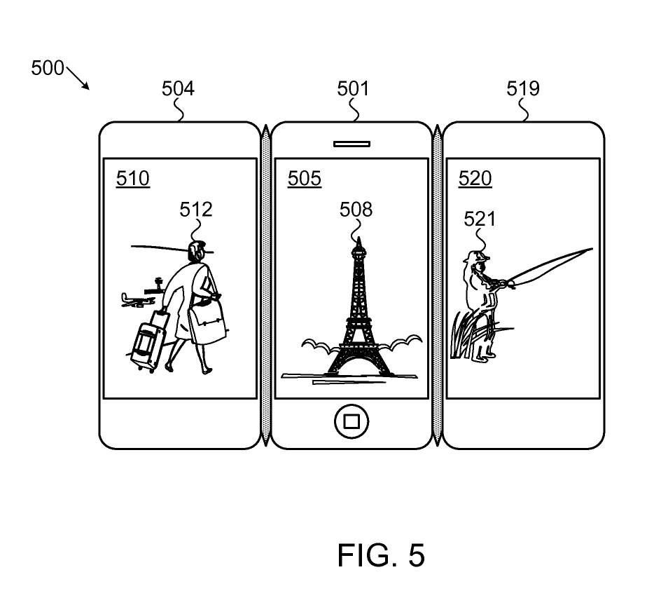

FIG. 5 shows a mobile device with three display units showing three different images, according to some exemplary embodiments of the subject matter. The mobile device 500 comprises three display units, a left display unit 510, a main display unit 505 and a right display unit 520. Each display unit of the three display units 510, 505, 520 is enabled to display a different image according to what a user wants to watch or according to a command from the designation unit 115. For example, the left display unit 510 shows three people walking together, the main display unit 505 shows an image of the Eiffel tower, and the right display unit 520 shows an image of man fishing on a boat.

FIG. 6 shows a mobile device with a plurality of display units showing a single image, according to some exemplary embodiments of the subject matter. The mobile device 600 comprises six display units, a main display unit 605, a left display unit 610, a top left display unit 620, a top display unit 630, a top right display unit 640, and a right display unit 650. Each display unit of the six display unit shows a portion of an image to enable a single user or a group of users to watch an enlarged image.

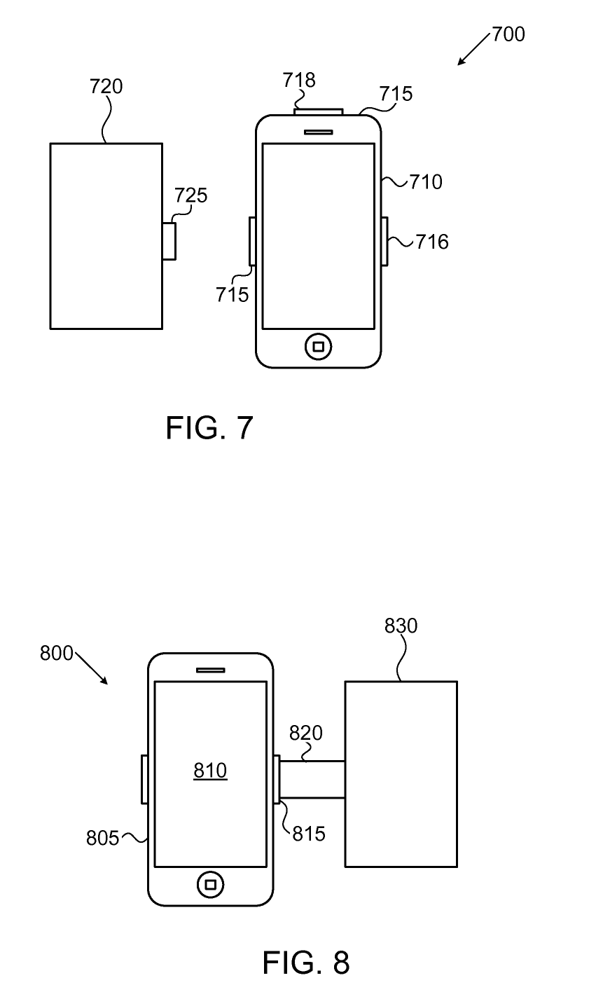

FIG. 7 shows a mobile device with a wireless display unit, according to some exemplary embodiments of the subject matter. The mobile device 700 comprises a display unit 710 and a body 705. The body 705 comprises a plurality of connectors, for example a left connector 715, a right connector 716, and a top connector 718. The plurality of connectors enable connecting a plurality of display units to the body 705 of the mobile device 700. For example a display unit connector 725 enables connecting the display unit 720 to a connector of the plurality of display units of the mobile device 700. In some exemplary embodiments of the subject matter, the display unit 720 comprises the display unit transceiver 210 of FIG. 2, which enables using the display unit wirelessly. The mobile device 700 transmits data to the display unit 720 through the transceiver 140 of FIG. 1.

FIG. 8 shows a mobile device with a display unit connected through an extendable wire, according to some exemplary embodiments of the subject matter. The mobile device 800 comprises a body 805 and a main display unit 810 comprises a connector 815. The connector 815 comprises a wire 820 connected to a display unit 830. The mobile device 800 communicates with the display unit 830. In some cases, the wire 820 may be extended to enable a user to move further away from the mobile device 800 while using the display unit 830.

FIG. 9 shows a mobile device with a display unit arranged at a corner of the mobile device, according to some exemplary embodiment of the subject matter. The mobile device 900 comprises a main body 905 and a main display 910. The mobile device comprises a plurality of display units, for example a display unit 915. The display unit 915 is connected to the body 905 by a connector 920, which enables the display unit 915 to be glided along a rail 918. In some cases, the display unit 915 comprises a display unit rail which enables arranging the display unit 915 in different predetermined angles from the body 905. The display unit 915 comprises one or more balancing units, which are located along a casing 930 of the display unit 915, for example a first balancing unit 931 and a second balancing unit 932.

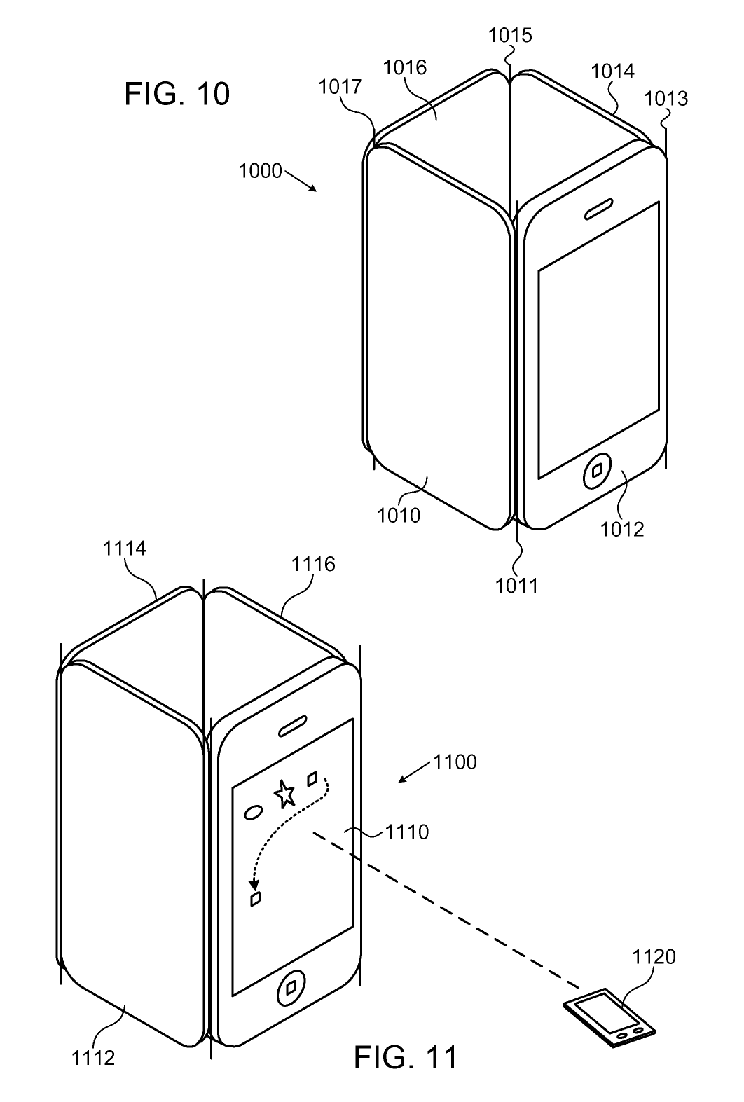

FIG. 10 shows a mobile device with a plurality of display units arranged in a closed configuration, according to some exemplary embodiment of the subject matter. The closed configuration is defined as a state in which all the display units form a polygonal shape. In FIG. 10, four (4) display units 1010, 1012, 1014, 1016 form a rectangular. In some exemplary cases, one display unit of the plurality of display units 1010, 1012, 1014, 1016 is a main display unit, as discussed above. The plurality of display units 1010, 1012, 1014, 1016 may be connected via pins that enable rotational movement of one display unit versus the other. For example, pin 1011 connects the display units 1010 and 1012, pin 1013 connects the display units 1012 and 1014, pin 1015 connects the display units 1014 and 1016, pin 1017 connects the display units 1016 and 1010. The pins may be removable from the display units, or be embedded therein.

The four (4) display units 1010, 1012, 1014, 1016 arranged in a closed, configuration enable a group of persons sitting in different directions from the mobile device 1000 to view the same content, in case the same content is displayed in each of the display units 1010, 1012, 1014, 1016. In some exemplary cases, at least a portion of the display units 1010, 1012, 1014, 1016 comprise a camera, such that various images are captured from various directions from the mobile device 1000. For example, in case 4 persons sit around the mobile device 1000, each of the 4 persons faces another display unit of the display units 1010, 1012, 1014, 1016, a processor inside the mobile device may generate one image with the 4 persons and send the image to a remote location, for example during a video call or a video conference. In some exemplary cases, at least a portion of the display units 1010, 1012, 1014, 1016 comprise a microphone to enable users to input voice into the display units, for example in order to input commands or to have voice communication, match his voice signature with the specific display unit he is using, conference calls and the like.

FIG. 11 shows a mobile device controlled by a remote control unit, according to exemplary embodiments of the subject matter. The mobile device 1100 of FIG. 11 is arranged in a closed configuration and comprises display units 1110, 1112, 1114. 1116. In other cases, the mobile device may be arranged in a unified display configuration or any other configuration desired by a person skilled in the art. At least one of the display units 1110. 1112, 1114, 1116 is controlled by a remote control unit 1120, which generates a laser beam or light towards the mobile device 1100. The remote control unit 1120 may generate commands to be executed by software or hardware modules associated with the mobile device 1100, for example opening a mobile application 1130, such as a mobile application that broadcasts news, or taking a picture using a camera installed in one of the display units 1110, 1112, 1114, 1116. In some exemplary cases, control signals may be transmitted between the display units 1110, 1112, 1114, 1116, such that in case the remote control unit 1120 performs an action on one display unit, such as opening a file or deleting a file on display unit 1110, the display units 1112, 1114, 1116 will show the action performed by the remote control unit 1120. In some exemplary cases, the remote control unit 1120 may move an icon from one display unit to another, for example using a predefined gesture.

In some exemplary cases, the remote control is activated upon identification of a person, for example having a fingerprint detection sensor in the remote control unit. The fingerprint detection sensor communicates with the electronic device, and ensures that only a verified user can operate the remote control and thus control a display unit and/or the entire mobile device 1100.

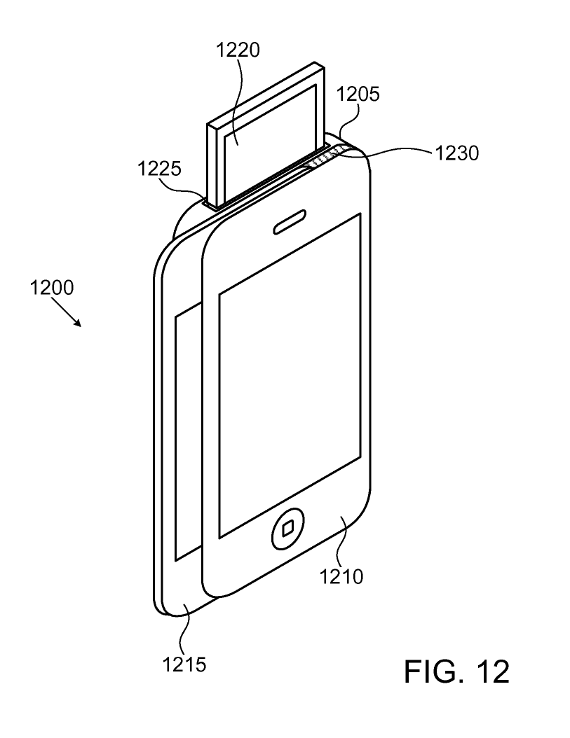

FIG. 12 shows a mobile device, according to exemplary embodiments of the subject matter. The mobile device 1200 has a main display unit 1210 on one side of a body 1205. The body 1205 includes at least one compartment that contain a second display unit 1215 and a third display unit 1220. The user of the mobile device 1200 may remove at least one of the second display unit 1215 and the third display unit 1220 from the body 1205, for example by pressing a physical button 1230. It can be seen that the only a portion of the third display unit 1220 is slid out of the body 1205. In such a case, the content displayed in the portion of the third display unit 1220 which is visible to the user of the mobile device 1200 is determined according to the visible portion extending from the body 1205. For example, a size of an image displayed on the third display unit 1220 may he adjusted when the visible portion of the third display unit 1220 changes from 30 percent to 50 percent.

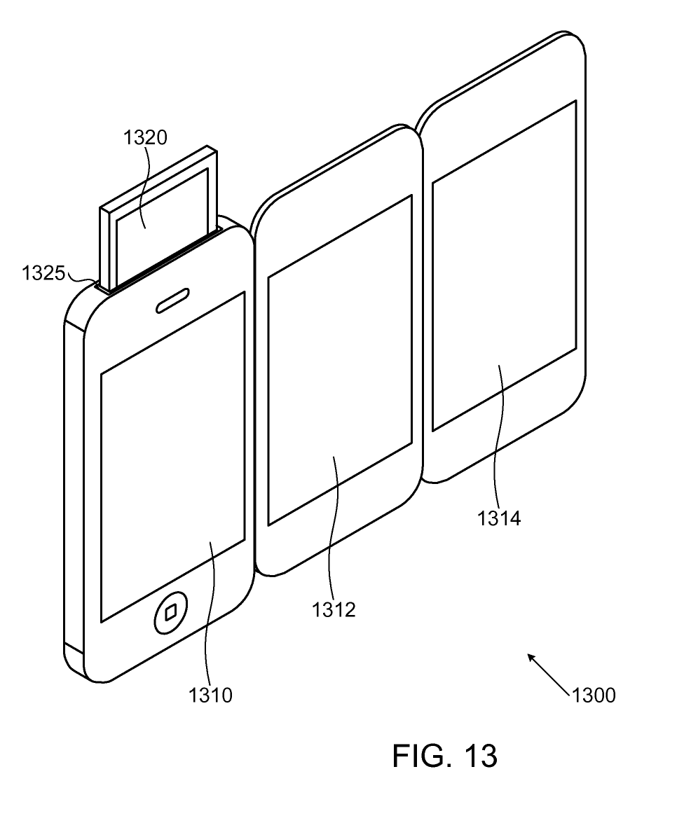

FIG. 13 shows a mobile device, according to exemplary embodiments of the subject matter. The mobile device 1300 comprises a main unit with a display unit 1310. A top display unit 1320 slides from the main unit via a top opening 1325. Two additional display units 1312 and 1314 are attached to the display unit. The additional display units 1312 and 1314 may be slid from the main unit or may be attached via physical connectors such as pins. In some cases, the display units 1310, 1312, 1314 show a unified image, such as a movie, to form a display in a size of a tablet computer or a mini tablet. Simultaneously, the top display unit may show personalized content, such as an email application the user wishes to view while viewing the movie in the enlarged display composed by positioning the display units 1310, 1312, 1314 one by the other.

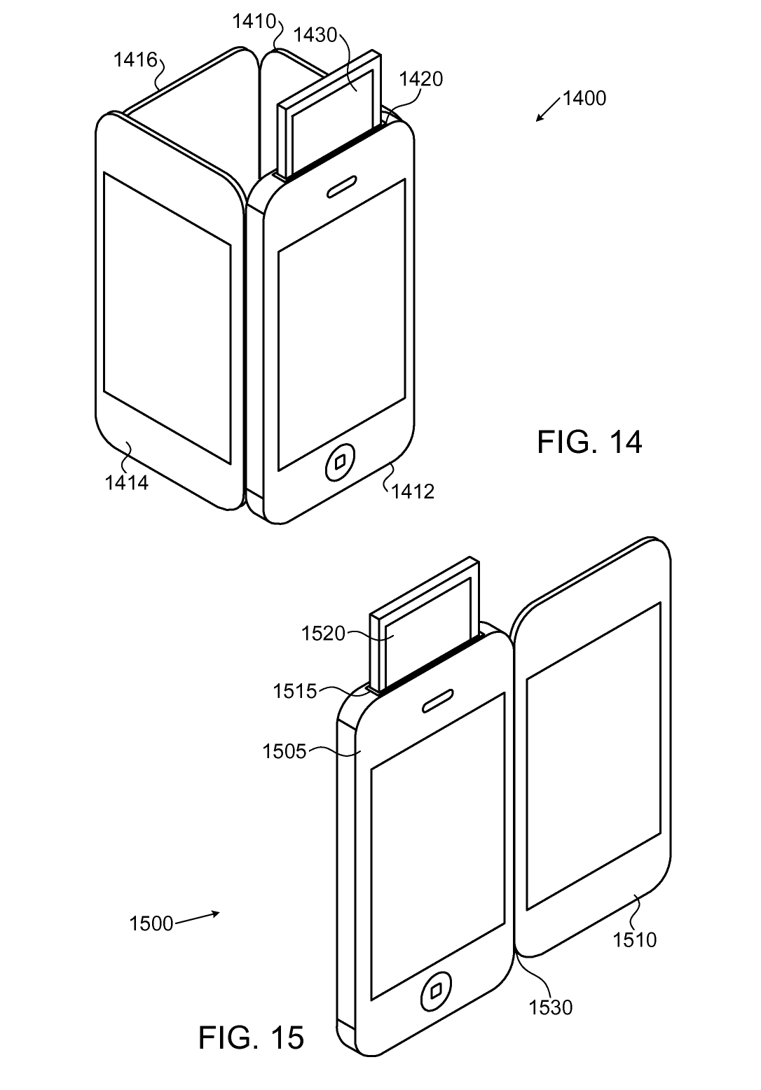

FIG. 14 shows a mobile device in a closed configuration, according to exemplary embodiments of the subject matters The mobile device 1400 comprises our display units 1410, 1412, 1414, 1416 that form a polygonal shape in which the mobile device can show content in different directions. Another display unit 1430 extends from the body of the display unit 1412 via opening 1420. The display unit 1430 enables a person viewing the content displayed in display unit 1412 to view additional content. For example, in case all the display units 1410, 1412, 1414, 1416 show the same content, the display unit 1430 can show content which is personalized. The personalized content may be provided upon authentication, for example voice authentication, authentication by camera or another biometric authentication and identification. In some cases, such authentication results in activation at least one display unit of the plurality of display units.

FIG. 15 shows a mobile device with three display units, according to exemplary embodiments of the subject matter. The mobile device 1500 comprises a main unit 1505 with a display device. The main unit 1505 comprises a compartment with a second display unit 1520 which is slidable upwards, via a top opening 1515. The main unit 1505 is connected to a lateral display unit 1510 via a connector 1530, such as a pin. The user of the mobile device 1500 may review unified content in the display units 1505 and 1520 and different content in the display unit 1520.

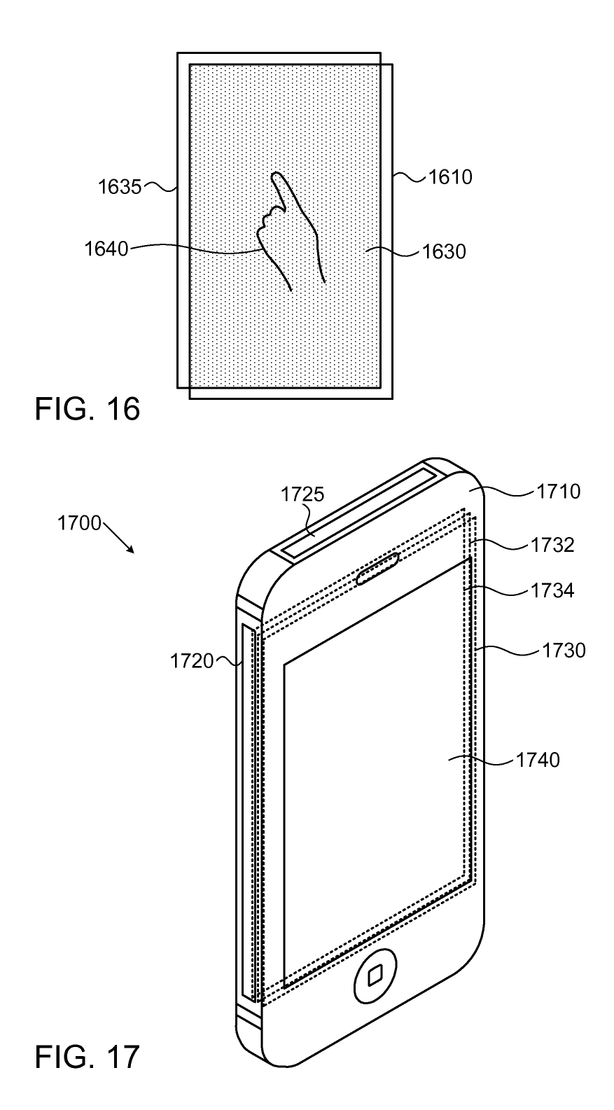

FIG. 16 shows a mobile device with two transparent display units, according to exemplary embodiments of the subject matter. The mobile device 1600 comprises a first display unit 1610 and a second display unit 1635. The first display unit 1610 and a second display unit 1635 are transparent and can be mounted one on top of the other, for example when they are connected via a hinge. In some other cases, there is a mechanism which affixes the position of one transparent display unit exactly on top of the other. The first display unit 1610 and a second display unit 1635 may be of the same size. The two transparent display units enable comparison of images, for example for medical purposes.

Having at least two transparent or semi-transparent display units enable comparison of an image displayed on the first display unit 1610 to another image displayed on the second display unit 1635. Comparison between the two images may be performed by a processor that reside in the body of the mobile device 1600 or in one of the display units. Such comparison may be used for medical purposes, for example comparing an image taken a week ago and another image taken 8 weeks ago. The processor may be configured to manipulate at least one of the images, for example to resize the image, perform image registration, and change other parameters such as brightness and the like.

The two or more transparent or semi-transparent display units may be mounted one over the other. A stack of transparent display units may create a 3D display, The 3D display may be visible when the stacked display units are inside the body of the mobile device 1600, in case at least one side of the body is also transparent. Stacked transparent display units also enable overlaying data or applications one on the other—for example, displaying editing tools on top of a display unit showing a photo, and having a third display unit that show the edited image or meta-data of a photo, or social network data relating to the photo. The transparent display units can be used and controlled also when stored inside the compartment of the mobile device 1600.

FIG. 17 shows a mobile device with three display units inside a compartment, according to exemplary embodiments of the subject matter. FIG. 17 shows a mobile device 1700 with a compartment 1710 for storing additional display units 1730, 1732, 1734 which are removable from the compartment 1710, for example via to opening 1725 or side opening 1720. The compartment 1710 is connected to the main display unit 1740.

While the disclosure has been described with reference to exemplary embodiments, it will be understood by those skilled in the art that various changes may be made and equivalents may be substituted for elements thereof without departing from the scope of the subject matter. In addition, many modifications may he made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A mobile device comprising:
a body, comprising a processor and a memory;
a plurality of display units, wherein each display unit of the plurality of display units is arranged according to a predefined configuration, at least one of the plurality of display units receives data from the body;
a plurality of connectors configured to connect the plurality of display units such that data flows from one display unit to another display unit via a connector of the plurality of connectors;
a designation unit to designate what is displayed on each display of the plurality of display units;
at least one display unit compartment inside the body for storing the plurality of display units, a display unit of the plurality of display units is slide-able out of the at least one display unit compartment;
wherein the predefined configuration is the plurality of display units arranged in a polygonal shape;
wherein the polygonal shape enables a group of persons sitting in different directions from the mobile device to view the same and different content.

2. The mobile device of claim 1, wherein, the plurality of connectors enable folding the plurality of the display units into the predefined configurations.

3. The mobile device of claim 2, wherein the designation unit designates a portion of an image to be displayed in each display unit of the plurality of display units, such that the image is displayed by the plurality of display units.

4. The mobile device of claim 2, wherein the designation unit designates a different display to each display unit of the plurality of display units.

5. The mobile device of claim 1, wherein at least one connector of the plurality of connectors enables disconnecting a display unit of the plurality of display units from the mobile device.

6. The mobile device of claim 5, wherein at least one display unit of the plurality of display units comprises a transceiver unit to wirelessly transmit and receive data from the body of the mobile device.

7. The mobile device of claim 1, wherein at least one connector of the plurality of connectors comprises a wire line connection that enables extending the distance from a display unit of the plurality of display units and the body of the mobile device.

8. The mobile device of claim 1, wherein at least one connector of the plurality of connectors enables a display unit of the plurality of display units to rotate relative to a surface of the body of the mobile device, wherein the display unit is connected to the body.

9. The mobile device of claim 8, wherein two display units of the plurality of the display units are connected to the body via two different connectors of the plurality of connectors, wherein the two different connectors enable the two display units to rotate relative to the surface of the body of the mobile device.

10. The mobile device of claim 1, wherein a display unit of the plurality of display units folds from a bottom of the mobile device.

11. The mobile device of claim 1, further comprising an orientation unit to obtain an orientation data of at least one display unit of the plurality of display units, wherein the designation unit determines the display of the at least one display unit according to orientation data.

12. The mobile device of claim 11, wherein the orientation unit stabilizes and orients a display of the at least one display unit of the plurality of display units according to location, movement and orientation of the at least one display unit of the plurality of display units.

13. The mobile device, of claim 1, further comprising a display optimization unit to correct environmental effect on an image quality of a display unit of the plurality of display units.

14. The mobile device of claim 1, further comprising a plurality of input units, each input unit is associated with a display unit of the plurality of display units, said plurality of input units receive commands from one or more users viewing the plurality of displays.

15. The mobile device of claim 14, wherein each input unit of the plurality of input units recognizes voice commands of a user.

16. The mobile device of claim 15, wherein a display unit of the plurality of display units displays personalized content of the user recognized by the input unit.

17. The mobile device of claim 14, wherein an input unit of the plurality of input units is a remote control.

18. The mobile device of claim 17, wherein the remote control is activated upon identification of a person using a fingerprint detection sensor.

19. The mobile device of claim 1, wherein each display unit of the plurality of display units is customizable according to a user's predefined specification.

20. The mobile device of claim 1, wherein the display unit is automatically activated responsive to being slide-able out of the at least one display unit compartment.

21. The mobile device of claim 1, wherein the body comprises at least two openings, wherein at least two display units of the plurality of display units are slide-able from the at least one display unit compartment via the at least two openings.

22. The mobile device of claim 21, wherein the body stores at least two display units in the at least one display unit compartment, wherein the at least two display units are horizontally and/or vertically stacked.

23. The mobile device of claim 22, wherein at least one display unit of the at least two display units comprises a second display unit compartment, said second display unit compartment stores additional display units.

24. The mobile device of claim 1, wherein the designation unit enables dragging an item from a first display unit of the plurality of the display units to a second display unit of the plurality of the display units.

25. The mobile device of claim 1, wherein a portion of a first display unit protrudes from another display unit, wherein the designation unit determines the display of the first display unit according to the portion of the first display unit not overlapped by the second display unit.

26. The mobile device of claim 1, wherein at least a portion of the plurality of display units is configured to show personalized content.

27. The mobile device of claim 26, wherein personalized content associated with two persons is displayed simultaneously via three display units of the plurality of display units.

28. The mobile device of claim 1, wherein the predefined configuration is a closed configuration.

29. A mobile device comprising:
a body, comprising a processor and a memory;
a plurality of transparent display units, at least one of the plurality of display units receives data from the body, wherein the plurality of transparent display units are arranged in a polygonal shape, at least one of the plurality of transparent display units receives data from the body;
a plurality of connectors configured to connect the plurality of display units such that data flows from one display unit to another display unit via a connector of the plurality of connectors;
a designation unit to designate what is displayed on each display of the plurality of display units;
at least one display unit compartment inside the body for storing the plurality of display units, a display unit of the plurality of display units is slide-able out of the at least one display unit compartment;
wherein the polygonal shape enables a group of persons sitting in different directions from the mobile device to view the same and different content;

30. The mobile device according to claim 29, wherein at least three transparent display units are foldable, to be mounted one on top of the other.

31. The mobile device according to claim 30, wherein the foldable at least three transparent display units are configured to compare a first image displayed on a first display unit of the least three transparent display units and a second image displayed on a second display unit of the least three transparent display units.

32. The mobile device according to claim 29, wherein the compartment is transparent.

33. The mobile device according to claim 32, wherein at least one display unit of the plurality of transparent display units display data when positioned inside the compartment.

34. The mobile device according to claim 29, wherein at least one display unit of the plurality of transparent is controlled and activated when positioned inside the compartment.

35. A mobile device comprising:
a body, comprising a processor and a memory;
a plurality of display units, wherein each display unit of the plurality of display units is arranged according to a predefined configuration at least one of the plurality of display units receives data from the body;
a plurality of connectors configured to connect the plurality of display units such that data flows from one display unit to another display unit via a connector of the plurality of connectors;
a designation unit to designate what is displayed on each display of the plurality of display units.
at least one display unit compartment inside the body for storing the plurality of display units, a display unit of the plurality of display units is slide-able out of the at least one display unit compartment;
a plurality of input units, each input unit is associated with a display win of the plurality of display units, said plurality of input units receive commands from one or more users viewing the plurality of displays;
wherein the predefined configuration is an arrangement of the plurality of display units in a polygonal shape;
wherein the polygonal shape arrangement enables a group of persons sitting in different directions from the mobile device to view the same and different content;

36. The mobile device of claim 35, wherein the plurality of connectors enable folding the plurality of the display units into the predefined configuration.

37. The mobile device of claim 35, wherein the designation unit designates a different display to each display unit of the plurality of display units.

38. The mobile device of claim 35, wherein at least one connector of the plurality of connectors enables disconnecting a display unit of the plurality of display units from the mobile device.

39. The mobile device of claim 35, wherein at least one display Unit of the plurality of display units comprises a transceiver unit to wirelessly transmit and receive data from the body of the mobile device.

40. The mobile device of claim 35, wherein at least one connector of the plurality of connectors comprises a wire line connection that enables extending the distance from a display unit of the plurality of display units and the body of the mobile device.

41. The mobile device of claim 35, wherein at least one connector of the plurality of connectors enables a display unit of the plurality of display units to rotate relative to a surface of the body of the mobile device, wherein the display unit is connected to the body.
